(19) United States
(12) Patent Application Publication
(10) Pub. No.: US 2026/0245236 A1
(43) Pub. Date: Aug. 20, 2026

(54) WIDE-ANGLE MONOCULAR TRACKING USING MARKERS

(71) Applicant: THE JOHNS HOPKINS UNIVERSITY, Baltimore, MD (US)

(72) Inventors: Balazs P. VAGVOLGYI, Baltimore, MD (US); Ravikrishnan PERUR JAYAKUMAR, Baltimore, MD (US); Manu S. MADHAV, Vancouver, BC (CA); James KNIERIM, Baltimore, MD (US); Noah J. COWAN, Baltimore, MD (US)

(21) Appl. No.: 18/992,652

(22) PCT Filed: Aug. 1, 2023
(86) PCT No.: PCT/US2023/029184

§ 371 Date: Jan. 9, 2025

Related U.S. Application Data
(60) Provisional application No. 63/396,305, filed on Aug. 9, 2022.

(51) Int. Cl. G06T 7/73; B25J 13/08; G06T 7/246; H04N 23/21

(52) U.S. Cl. CPC G06T 7/73; B25J 13/089; G06T 7/246; H04N 23/21; G06T 2207/10048; G06T 2207/30204

(57) ABSTRACT

A system for and method of tracking an orientation of an object in a three-dimensional environment using image information acquired by a single camera is presented. The techniques include: acquiring a marker image depicting a portion of a set of markers rigidly positioned with respect to the object; for a predetermined anchor subset of the set of markers, determining a plurality of correspondences of a plurality of markers in the anchor subset to subsets of images of markers in the marker image; determining, for each of the correspondences, a respective orientation of the object; predicting, for each respective orientation of the object, a respective predicted position of a non-anchor marker; identifying a closest match of the marker image to one of the predicted positions of the non-anchor marker; determining an output orientation of the object corresponding to the closest match; and providing the output orientation of the object.

### CROSS-REFERENCE TO RELATED APPLICATIONS

This application is the national stage entry of International Patent Application No. PCT/US2023/029184, filed on Aug. 1, 2023, and published as WO 2024/035568 A1 on Feb. 15, 2024, which claims the benefit of U.S. Provisional Patent Application No. 63/396,305, filed on Aug. 9, 2022, which are hereby incorporated by reference herein in their entireties.

### GOVERNMENT SUPPORT

This invention was made with government support under grants NS102537 and MH118926 awarded by the National Institutes of Health. The government has certain rights in the invention.

### FIELD

This disclosure relates generally to object tracking.

### BACKGROUND

Camera images can encode large amounts of visual information of a tracked object, e.g., a target on an animal, and its environment, enabling high fidelity 3D reconstruction of the animal and its environment using computer vision methods. Most systems, both markerless (e.g., deep learning based) and marker-based, require multiple cameras to track features across multiple points of view to enable such 3D reconstruction. However, such systems can be expensive and require specialized computing hardware, e.g., graphics processing units (GPUs). Further, such systems are challenging to set up, e.g., in small animal research apparatuses.

### SUMMARY

According to various embodiments, a method of tracking an orientation of an object in a three-dimensional environment using image information acquired by a single camera is presented. The method includes: acquiring, from the single camera, a marker image, the marker image depicting a portion of a set of markers rigidly positioned with respect to the object; for a predetermined anchor subset of the set of markers, determining, by an electronic processor communicatively coupled to the single camera, a plurality of correspondences of a plurality of markers in the anchor subset of markers to subsets of images of markers depicted in the marker image; determining, by the electronic processor, for each of the plurality of correspondences, a respective orientation of the object; predicting, by the electronic processor, for each respective orientation of the object, a respective predicted position of a non-anchor marker, where a plurality of predicted positions of the non-anchor marker are determined; identifying, by the electronic processor, a closest match of the marker image to one of the plurality of predicted positions of the non-anchor marker; determining, by the electronic processor, an output orientation of the object corresponding to the closest match; and providing, by the electronic processor, the output orientation of the object.

Various optional features of the above embodiments include the following. The object may be attached to an animal. The object may include a robot end effector. The method may further include controlling the robot end effector based on the output orientation. The marker image may be monochromatic. The method may include determining an output position of the object based on the marker image; and providing an output position of the object. The method may be performed without use of a graphics processing unit (GPU). The method may include illuminating the object using a near infrared ring light positioned about an aperture of the camera. The method may include determining a subsequent output orientation of the object based on at least two prior output orientations of the object. The method may further include, prior to the acquiring, determining a plurality of anchor subsets of the set of markers, where the plurality of anchor subsets of the set of markers include the predetermined anchor subset of the set of markers.

According to various embodiments, a computer readable medium including instructions that, when executed by an electronic processor, configure the electronic processor to perform a method of tracking an orientation of an object in a three-dimensional environment using image information acquired by a single camera by performing actions is presented. The actions include: acquiring, from the single camera, a marker image, the marker image depicting a portion of a set of markers rigidly positioned with respect to the object; for a predetermined anchor subset of the set of markers, determining, by an electronic processor communicatively coupled to the single camera, a plurality of correspondences of a plurality of markers in the anchor subset of markers to subsets of images of markers depicted in the marker image; determining, by the electronic processor, for each of the plurality of correspondences, a respective orientation of the object; predicting, by the electronic processor, for each respective orientation of the object, a respective predicted position of a non-anchor marker, where a plurality of predicted positions of the non-anchor marker are determined; identifying, by the electronic processor, a closest match of the marker image to one of the plurality of predicted positions of the non-anchor marker; determining, by the electronic processor, an output orientation of the object corresponding to the closest match; and providing, by the electronic processor, the output orientation of the object.

Various optional features of the above embodiments include the following. The object may be attached to an animal. The object may include a robot end effector. The actions may further include controlling the robot end effector based on the output orientation. The marker image may be monochromatic. The actions may further include: determining an output position of the object based on the marker image; and providing an output position of the object. The actions may be performable without use of a graphics processing unit (GPU). A near infrared ring light positioned about an aperture of the camera may illuminate the object. The actions may further include determining a subsequent output orientation of the object based on at least two prior output orientations of the object. The actions may further include, prior to the acquiring, determining a plurality of anchor subsets of the set of markers, where the plurality of anchor subsets of the set of markers include the predetermined anchor subset of the set of markers.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts a visual target according to a reduction to practice;

FIG. 2 is an overview of various parts of a tracking algorithm according to various embodiments;

FIG. 3 is a high-level flow chart for a tracking algorithm according to various embodiments;

FIG. 4 is a flow chart illustrating sub-processing steps and the combinatorial phase of a tracking algorithm according to various embodiments;

FIG. 5 depicts trees used for an optimization phase of an anchor set selection algorithm;

FIG. 6 is a schematic diagram of system architecture used in the reduction to practice

FIG. 7 illustrates an experimental setup used to evaluate the accuracy of the reduction to practice;

FIG. 8 depicts graphs comparing position and orientation accuracy of the reduction to practice to a commercially available system;

FIG. 9 depicts a setup used to test the reliability of the reduction to practice;

FIG. 10 shows the trajectory of the visual target of the reduction to practice mounted on the head of the animal during the 2.5 h run time of the experiment with automatic anchor set optimization enabled; and

FIG. 11 shows the spatially selective neural activity of typical head direction cells and place cells from a single session of a rat running on a circular track collected using the reduction to practice.

### DESCRIPTION OF THE EMBODIMENTS

Reference will now be made in detail to example implementations, illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

Some embodiments provide a single-camera real-time system for tracking in a 3D environment that includes a non-planar marker design that is small and detectable from most orientations and a corresponding tracking algorithm that can handle the situation when only a subset of the marker's features is visible, e.g., due to occlusions. Some embodiments include a marker-based system that uses only a single camera with a wide field of view. Some embodiments include a lightweight visual target and computer vision algorithms that together allow for high-accuracy tracking of the six-degree-of-freedom position and orientation of the target. Some embodiments can provide real-time tracking using only a single camera and computational hardware with a single central processing unit, as opposed to, for example, one or multiple GPUs.

Thus, some embodiments provide a monocular 3D tracking system suitable for small animal tracking (by way of non-limiting example) that includes of a compact, lightweight visual target comprising a set of retro-reflective markers, a camera equipped with a ring-light, and a personal computer. According to some embodiments, the visual target allows for the calculation of pose estimates from almost any orientation using a computer vision algorithm that is capable of solving the difficult correspondence problem between markers and observations in real time. Some embodiments allow for high-accuracy 3D tracking over a significantly wider range of view angles than prior art systems. According to some embodiments, marker localization is performed using model-based image processing methods, and 3D pose estimation is performed through the use of a Perspective-n-Point (“PnP”) algorithm.

Embodiments may be used to track an animal or portion thereof, e.g., a rat's head in a behavioral research environment. Such embodiments, which only require a single camera positioned above the behavioral arena, robustly reconstruct the pose over a wide range of head angles (360° in yaw, and approximately ±120° in roll and pitch).

Embodiments are not limited to tracking animals. Various embodiments may track any object. For example, embodiments may track a robotic end effector using a single camera and markers rigidly positioned with respect to the robot end effector.

Experiments with live animals have demonstrated that an embodiment can reliably identify rat head position and orientation in a complex 3D environment. Comparative evaluations to a commercial optical tracker device have shown that an embodiment achieved accuracy that rivals commercial multi-camera systems. Further, embodiments significantly improve upon existing monocular marker-based tracking methods, both in accuracy and in allowable range of motion. Thus, embodiments allow for the study of complex laboratory animal behaviors, for example, by providing robust, fine-scale measurements of rodent head motions in a wide range of orientations.

This disclosure uses the following terminology. A “marker” is an object, such as a retroreflective sphere or hemisphere, that is visible in a camera image, e.g., as a bright spot in the image when illuminated by a ring light mounted on the camera lens. By contrast, an “observation” is an image of an object, such as a marker, as captured by a camera. For example, an observation may be a small bright spot detected on a camera's image representing a marker. However, an observation may be a spot that is not a marker, such as an image artifact (for example lens flare) or the reflection of a small glossy object other than a marker.

A “pose” is a combined position and orientation of a visual target. Position is described as a 3-vector of the 3D coordinates (x, y, z). While orientation can be represented many different ways, some embodiments quantify orientation as a quaternion (w, x, y, z). Pose is relative, so a user may specify the reference frame with respect to which pose is specified. According to some embodiments, by default, the tracker provides the visual target's pose with respect to the camera's coordinate frame, but embodiments may allow the user to specify another coordinate frame—also specified relative to the camera frame—to be the reference frame. As a convention, the position of the reference frame is usually aligned with some known physical object in the experiment, such as a point on the floor under the animal. The reference frame's orientation is often chosen so that the Z-axis aligns with the vertical direction and the XY-plane is parallel to the floor.

A “visual target” or “target” is a 3D object that includes a plurality of markers and is not rotationally symmetric. According to some embodiments, the visual target includes an assembly of markers mounted on a lightweight plastic frame that is sufficient to enable the unique determination of the pose of the target as it is tracked by a monocular tracking system.

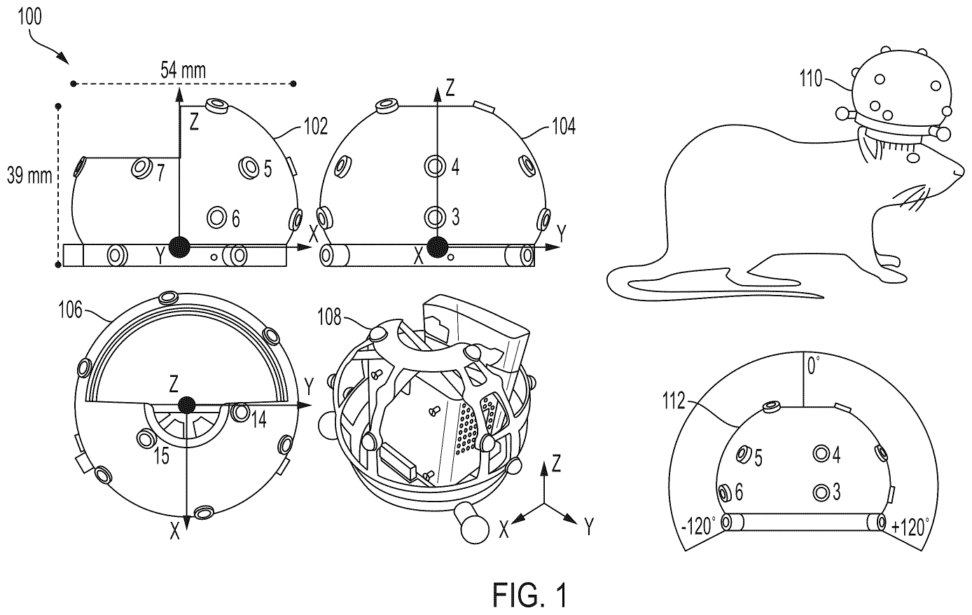

FIG. 1 depicts a visual target 102, 104, 106, 108, 110, 112 according to a reduction to practice. The visual target of FIG. 1 was reduced to practice for use in tracking small research animals. Design considerations included that the reduction to practice could be deployed with minimal effort on hardware commonly available in behavioral laboratories. Further design considerations for the reduction to practice included the following. Experiments often involve the construction of a test environment in which animals are placed, and the environment may need to be equipped with sensors and actuators. Electrophysiological or imaging equipment may also need to be deployed. Multi-camera tracking systems are expensive, require complex calibration and setup process, and need to share space with other, often bulky, equipment.

In order to accomplish 3D pose reconstruction from a single camera view, the reduction to practice includes a visual target 100 that allows for visibility from a wide range of perspectives and a corresponding software system that was able to identify its unique pose. The visual target 100 is lightweight and small in order to prevent it from interfering with behavior, but also strong enough to maintain structural integrity despite any impacts that it might sustain during behavior. Further, it accommodates electrophysiology equipment when mounted on the head of a rat.

The system of the reduction to practice uses infrared illumination, leaving the experimenter the freedom to employ whatever visible lighting condition is required for the purpose of the experiment. The tracking algorithm is able to fall back to 2D tracking when there is not enough information on the image to resolve accurate 3D pose, as can happen for example in behaviors such as grooming that introduce partial occlusions of the visual target.

The system of the reduction to practice operates in real time at a high frame rate on a personal computer equipped with a mainstream, 6-8 core CPU. System calibration and setup software allows end-users to build and run the system without further assistance. Finally, the system can store its results in an accessible format, communicate with other equipment involved in the experiment, and synchronize the tracking results with the rest of the apparatus.

As depicted in FIG. 1, the visual target is shown according to orthographic renderings 102, 104, 106 of the target's CAD model. The visual target of the reduction to practice measures 54×54×39 mm and weighs 3.5 g. It features 16 spherical or hemispherical retroreflective markers. The visual target of the reduction to practice is further depicted to show the retroreflective markers mounted on the target's clear plastic frame 106 that houses a wireless acquisition device and battery. The visual target of the reduction to practice is further shown mounted on the head of a rat at 110. As shown in the depiction of 112, the markers are arranged in a configuration that allows for full 3D (i.e., six degree-of-freedom position and orientation) tracking, allowing for full 360° rotation around the nominal z-axis, and up to approximately ±120° range around the nominal x and y axes. This allows an animal to fully explore an environment with substantial fore-aft (“pitching”) and side-to-side (“rolling”) of the head, without losing 3D reconstruction.

The visual target of the reduction to practice is small size and lightweight construction allow it to be mounted on small animals. The target structure is modularized with an external framework for the optical markers, which then mates with adapters specific to different electrophysiology headstages. The external framework has an opening on the top to allow for battery replacement without disassembly. The target of the reduction to practice includes a 3D printed plastic globe (with a diameter of 54 mm and a height of 39 mm) that has 16 sockets on its surface for holding retroreflective markers. Three of the markers are spheres of 7.9 mm diameter (size A) and the other 13 are hemispheres with a diameter of 3 mm (size B). Having retroreflective markers in two different sizes facilitate more efficient 3D pose estimation. The visual target weighs 3 g without and 3.5 g with the markers.

While the structure and dimensions of the reduction to practice target were optimized to fit over the electrophysiology equipment used in experiments using rats, the tracking method can localize optical targets of different size and marker configurations, thus the target can be scaled to be used with other species, such as mice and non-human primates, according to various embodiments. Further, the target can be used to track other objects, such as robotic end effectors, according to various embodiments.

The locations of the 16 retroreflective markers in the reduction to practice have been optimized so that at least six are always visible from any direction within the range of supported orientations, and that the geometrical configurations of visible markers are always unique. This allows the associated algorithm to calculate the rotation of the target corresponding to any supported physical orientation.

In reference to the coordinate frame depicted in FIG. 1, the visual target can be observed so long as the z-axis is rotated no more than 120° relative to the line of sight from the camera, i.e., the z-axis can cover more than an entire hemisphere. This range is typically sufficient to track the head of a small animal during a foraging and other behaviors where the animal is generally oriented upright. In other applications where the visibility of the subject is unobstructed from all angles, tracking the target from an additional camera, positioned opposite of the first one, could allow for uninterrupted tracking at any target orientation.

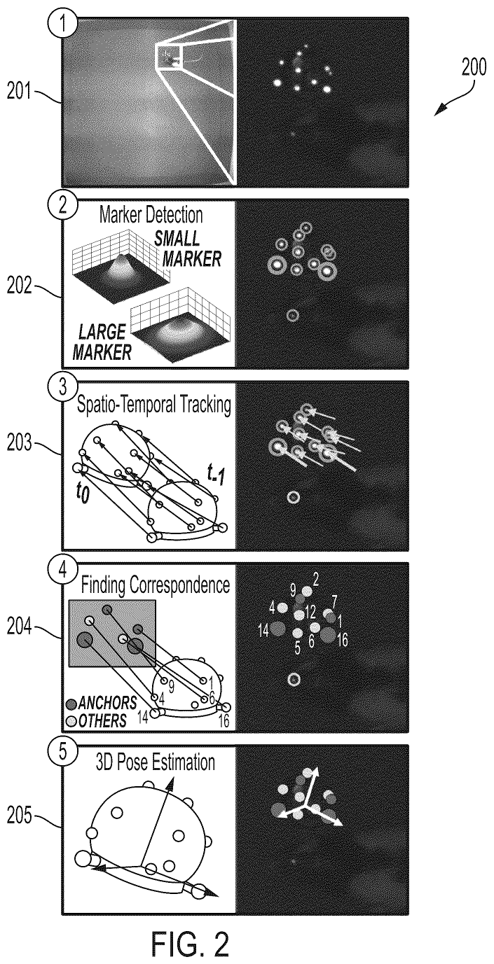

The tracking algorithm is described in detail in reference to FIGS. 2, 3, and 4. The tracking algorithm was designed to track the visual target by first locating the bright spots representing reflective markers on camera images (observations) and then resolving the observation-marker correspondence and the 3D pose of the target in a combined optimization framework. The target's 16 markers were arranged in a geometry such that the projection of those markers is unique from any point of view; therefore, the tracking algorithm will find a single unique solution for any given pose of the visual target.

The tracking algorithm includes three main steps: marker detection on video frames, spatiotemporal tracking of the target, and localization of the visual target by solving the correspondence problem. An optional initialization step—anchor set optimization—increases reliability by automatically finding the strongest visual features available on the target and optimizing the localization process for the detection of those features. The prerequisites of accurate and robust tracking are camera intrinsic calibration and proper camera exposure and focus, which are described in detail herein.

FIG. 2 is an overview of various parts of a tracking algorithm 200 according to various embodiments. The tracking algorithm includes: (1) Image capture and finding 201 the region-of-interest (ROI) on the grayscale image using connected component analysis and clustering, then dewarping the ROI to eliminate local camera distortions; (2) sub-pixel-accurate estimation of marker positions and recognition of marker sizes 202; (3) attempting to find marker correspondence by matching new marker detections to marker positions predicted from past trajectory (spatiotemporal tracking) 203; (4) performing combinatorial correspondence matching 204 when spatiotemporal tracking fails to determine correspondence; and (5) calculating a final 3D pose 205 from correspondence(s). The numerals (1), (2), (3), (4), and (5) represent corresponding actions in each of FIGS. 2, 3, and 4.

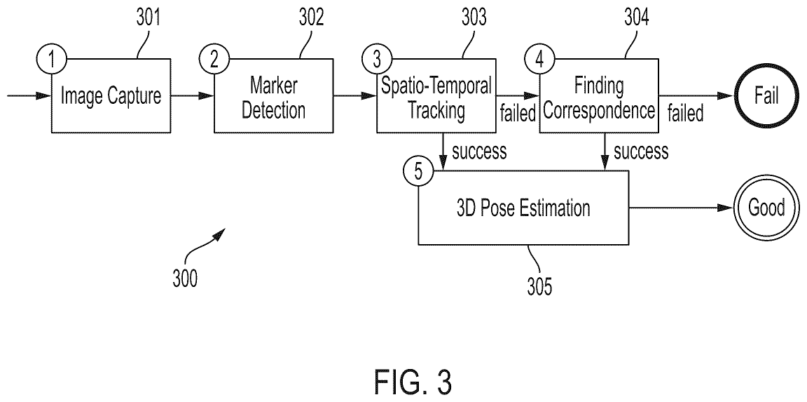

FIG. 3 is a high-level flow chart for a tracking algorithm 300 according to various embodiments. As shown in FIG. 3, the tracking algorithm includes (1) image capture and dewarping of ROI 301; (2) marker detection 302; (3) attempting to find marker correspondences using spatiotemporal tracking 303; (4) combinatorial correspondence matching 304 when spatiotemporal tracking has failed; and (5) calculating the 3D pose 305 from marker positions and correspondences.

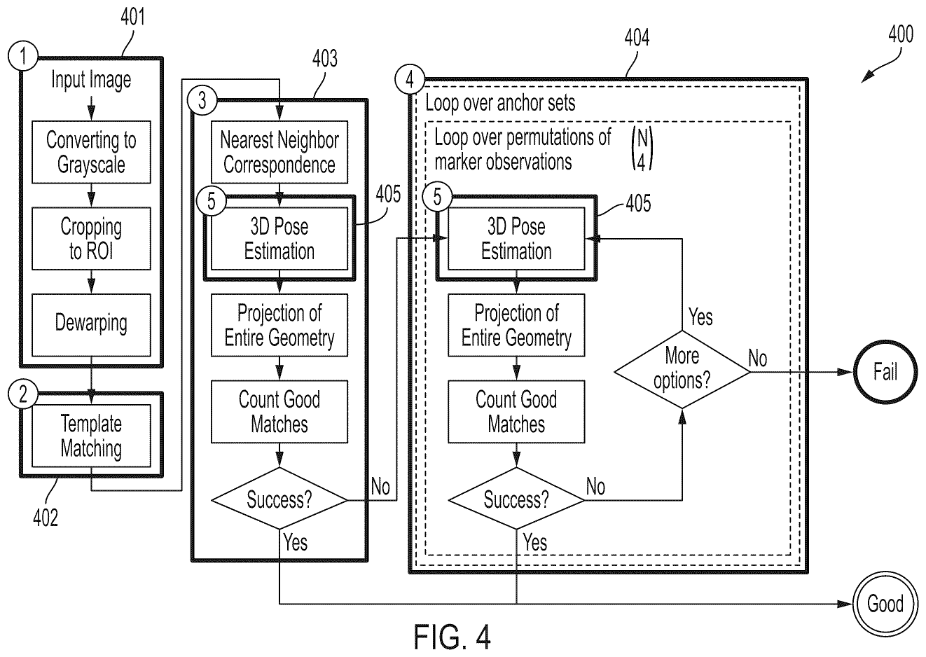

FIG. 4 is a flow chart illustrating sub-processing steps and the combinatorial phase of a tracking algorithm 400 according to various embodiments. As shown in FIG. 4, the algorithm includes (1) image acquisition 401, which includes, byway of non-limiting example, sub-steps of converting to greyscale, cropping to a ROI, and dewarping. The algorithm 400 also includes (2) marker detection 400 by template matching. The algorithm 400 also includes (3) spatiotemporal tracking 403, which utilizes a nearest neighbor correspondence technique and relies on a (5) previous 3D pose estimation 405. Spatiotemporal tracking 403 can further include projection of the determined geometry and counting good matches. If spatiotemporal tracking 403 is successful, then the results may be used to generate a final pose determination that is provided as an output of the algorithm 400. Otherwise, if unsuccessful, the algorithm 400 may utilize (4) combinatorial correspondence matching 404, which may include nested processing loops. The outer nested loop may be over a plurality of anchor subsets of markers. Anchor subsets are described further below. The inner nested loop may be over permutations of marker observations. The correspondence matching 404 may utilize a (5) previous pose estimation 405, which may be used to project the determined geometry and subsequently count good matches. If the correspondence matching 404 is successful, then the results may be used to generate a final pose determination that is provided as an output of the algorithm 400. Otherwise, if it is unsuccessful, then the inner loop may repeat if additional options are available. If unsuccessful and no further options are available, then the algorithm 400 may fail for the particular instance of image capture 401. In either case, another image may be captured, and the process repeated.

The various parts of the tracking algorithm as shown and described in reference to FIGS. 2, 3, and 4 are set forth in detail presently.

(1): Image capture may be accomplished by a camera equipped with a light ring, which may be infrared or near infrared. The camera may be monochromatic or color, but only monochromatic image information may be used according to various embodiments.

(2): Marker detection may be accomplished using template matching, which may be accomplished as follows. Tracking the visual target on any given image starts with simple image processing steps to locate a cluster of small bright spots on the image. First, the region-of-interest (ROI), defined by a bounding rectangle on the input video frame, is dewarped to eliminate radial distortion. The dewarping process uses camera intrinsic parameters determined during offline camera calibration. The ROI covers the area where the visual target is expected to appear on the image. Initially, the ROI covers the entire image, but after the first successful detection of the target, the ROI is narrowed down to a small neighborhood of the target's image position. The position of the ROI on new video frames is predicted based on the recent velocity of the target. If the tracker fails to locate the target, the ROI is gradually expanded until the target is located or eventually the ROI encompasses the entire image. When the target is successfully localized again, the ROI shrinks again to the narrow neighborhood around the target.

The target appears in the ROI as a cluster of small bright spots (observations). While most spots represent individual markers, some might be bright or shiny objects that are not part of the target. The marker detection algorithm identifies small bright spots by matching template images to the ROI. The number of templates is determined by how many unique sizes of markers are used in the visual target. The templates are 2D Gaussian functions generated to match the expected size of markers. The results of template matching are evaluated using normalized cross correlation (NCC), which is relatively insensitive to brightness and contrast variations. Bright spots that are dissimilar to the 2D Gaussian profile are discarded by template matching. Additional filtering steps eliminate markers that are outside a specified intensity range.

Once the initial collection of candidate markers is identified, the detection algorithm uses a clustering method to locate a single tight cluster among them. Candidates outside of the cluster are discarded as they are unlikely to be part of the target. Positions of spots are so far defined as pixel locations, which are only rough estimates of their actual positions. For sub-pixel accurate positions, the algorithm resamples the image of each candidate at 4× resolution using a 2D 4-lobed Lanczos kernel, and re-runs NCC-based template matching with 4× larger 2D Gaussian templates. The resulting matches on the oversampled image represent 0.25 pixel accuracy on the original image. Due to image noise and limited image resolution, resampling at even higher resolution does not seem to result in higher position accuracy.

(3): While the correspondence phase (4) is capable of determining the pose of the optical target on individual frames without having any knowledge of the pose of the target on preceding video frames, in behavioral tracking, the pose of the target can be expected to correlate with its pose on preceding frames. If the frame rate is adequately high compared to the rate of motion of the target, the pose changes between consecutive video frames can be estimated using spatiotemporal tracking techniques, described presently. The tracking method assumes that the position and orientation of the target changes smoothly in time and therefore their values can be predicted with reasonable accuracy at least one frame time ahead. When the tracker is able to successfully determine the pose of the target for at least two consecutive frames, it calculates the angular and translational velocities of the target based on these frames and predicts the pose for the next video frame by assuming constant velocity. When the next video frame arrives, it detects the positions of bright spots on the image in the neighborhood of the predicted position and matches the observations to the predicted marker positions using the nearest neighbor method. Once a correspondence is established, it is tested for validity using the PnP algorithm. If the resulting 3D pose is near the predicted pose, the new pose is accepted and the tracker skips the time-consuming correspondence computations (4).

(4) and (5): A description of the correspondence problem and pose estimation follows presently.

By way of background, the 3D pose of a 3D point cloud can be unambiguously calculated from its 2D projection if there are at least four non-co-linear points in the point cloud and the correspondence between the projections and the 3D points is known. The quality of the resulting pose estimate can be measured by using the estimated pose to reproject the point cloud onto the image plane and measuring the distance (reprojection error) between the reprojected point coordinates and the original projections. If the correspondence between projections and the points is not known, an algorithm may generate a list of potential correspondences and test them by measuring the reprojection error. However, the process of perspective projection from 3D to 2D reduces the dimensionality of the data and enables configurations where multiple different 3D point clouds projected from different 3D poses yield identical or very similar 2D projections. The chance of this ambiguity is particularly high when there are only four points in the point cloud, in which case it is likely that there are multiple potential correspondences with low reprojection error, making it highly difficult to find the correct correspondence. Increasing the number of points to five in the point cloud can eliminate or drastically reduce the chances of multiple correspondences with low reprojection error if the 3D configuration of the points is chosen suitably, for example by avoiding symmetries. Therefore, according to some embodiments, the minimum number of matched markers is set to six in order to minimize the chance of ambiguous correspondences, and markers on the visual target are mounted in a geometrical configuration that reduces potential ambiguities.

A detailed description of solving the correspondence problem (4) follows. The marker detection phase (2) provides a list of marker observations without further hints on their correspondence to physical markers. When the appearances of markers are indistinguishable from each other, correspondence between the detected spots on images and the points in the point cloud can be established in multiple ways. The number of possible correspondences is characterized by the permutation

$${P}_{m}^{d} ,$$

with

$${P}_{m}^{d} = ( \begin{matrix}d \\ m\end{matrix} ) = \frac{d}{( d - m ) !} \qquad ( 1 )$$

where m is the number of markers in the optical target and d is the number of detected spots on the image, i.e., the observations.

$${P}_{m}^{d}$$

is relatively low if there are few markers and few observations but increases faster than exponentially when the number of markers and observations grow. For instance, for 10 observations and 6 markers (a common use case), the number of possible correspondences is 151,200—a brute force method would struggle to process these correspondences in real time at a high frame rate.

Knowing the 3D geometry of the markers and the optical properties of the camera can be used to decrease the number of possible correspondences. The reduction to practice implemented three improvements for reducing combinatorial complexity: (1) evaluate all possible correspondences only for 4 special markers (anchors) and rely on the known geometry of the remaining markers to select the correct correspondence, (2) use markers of multiple sizes, which enables the marker detector to separate observations into multiple groups, and (3) introduce simple geometrical constraints on how the markers are expected to be projected onto images, allowing for fast filtering of invalid configurations. In general, anchors form a subset of markers on the target.

In the reduction to practice, introducing anchors reduces the number of comparisons by a factor of 30, from 151,200 to 5,040 (m=4 in Equation 1). There are ≥6 markers visible from any orientation, and at any particular orientation, 4 of the visible markers are designated as an anchor set. To find the correct correspondence between markers and observations, the algorithm first calculates—for each possible anchor correspondence—the 3D pose of the target (using the Perspective-n-Point (PnP) algorithm), which then allows for the prediction of the positions for the remaining visible non-anchor markers. The predicted marker positions are matched with the observations on the image using the nearest neighbor method under the 2D Euclidean distance metric. The configuration with the highest number of non-anchor markers that match the observations is then selected as the correct correspondence. Once the correspondence for all the matching observations is established, the 3D pose is refined by another run of the PnP algorithm using all the matched observations that results in a more accurate measurement than the initial estimate based on only 4 anchors. Note that 4 anchors is non-limiting, other numbers of anchors may be used according to various embodiments.

While using anchors reduces the combinatorial complexity significantly, the selection of these 4 anchors limits the range of directions from which the target can be tracked. The target of the reduction to practice has 16 markers with 6 guaranteed to be visible from any particular direction—therefore an anchor set will only be detectable when the target is oriented such that all the anchors in the set are visible. To solve this, the tracking algorithm uses multiple anchor subsets of the set of markers, each representing a limited range of orientations from which the target is observed. The combination of all anchor sets completely cover the supported range of orientations. With this, the maximum number of comparisons is reduced to

$${n}_{a} {P}_{m}^{d} ,$$

where nₐ is the number of anchor sets. (As used herein, an anchor set of markers may be referred to as a “subset” in reference to the full set of markers, or simply as a “set.”)

The list of anchor sets may be sorted between frames (i.e., captured images) to reduce the actual number of correspondence comparisons even further. The algorithm performs correspondence comparisons sequentially from the list of nₐ anchor sets. Once an anchor set is found, the algorithm tries that anchor set first for consecutive video frames. When the orientation of the target changes so much that the initial anchor set is not fully visible anymore, the algorithm will sequentially proceed through the list. The list of anchor sets is periodically re-sorted in descending order of utilization. The search thus starts with the most likely-to-succeed anchor sets, based on recent usage statistics.

According to various embodiments a visual target may include multiple marker sizes. During the marker detection phase (2), bright spots are classified to one of the size classes based on their matches to the different size 2D Gaussian kernels. In the correspondence phase (4), each marker is only matched to observations in its own size class, thereby reducing the number of correspondence comparisons by a significant amount. For instance, with 2 types of markers (large and small), 2 large and 8 small marker observations, and one anchor set featuring 1 large and 3 small markers, the number of comparisons is

$${P}_{1}^{8} \times {P}_{1}^{2} = 672 .$$

If marker sizes are ignored, the number of comparisons is

$${P}_{4}^{10} = 5040 .$$

Another optional feature according to various embodiments is filtering configurations. This feature takes advantage of the properties of perspective projection to eliminate certain anchor observation configurations from correspondence comparison. When four 3D points that define the corners of a polygon are projected using perspective projection to a 2D surface, certain properties are preserved such as convexity and whether the points of a convex quadrilateral are defined in clockwise or counterclockwise direction. Testing these properties of a four sided polygon in 2D is simple and efficient. The tracker algorithm of the reduction to practice uses anchor sets defined as sets of 4 anchors that are approximately on the same plane, they define a convex shape on their plane, and the corners are defined in clockwise order when observed from the visible side. When these requirements are met, the camera projection of the visible anchor sets also describe a convex 2D polygon with its corners defined in clockwise order. In the correspondence comparison, the algorithm checks if any given set of 4 observations that are to be matched with 4 anchors meets these requirements before attempting to perform pose estimation. Configurations not meeting the criteria are discarded, which cuts the number of fully evaluated configurations by a factor of

$$\frac{36}{25} \times \frac{24}{4} = 8.64 ,$$

as the probability of four randomly picked points on a rectangular plane to form a convex polygon is 25/36, and 4/24 ordered sequences of four such points are clockwise.

Anchor subsets of the set of markers on the target may be selected prior to tracking according to a process referred to herein as anchor set selection. The tracking algorithm uses enough anchor sets to cover all supported orientations, but using too many anchor sets slows down processing. Finding the right balance between the number of anchor sets and the anchor configurations inside those anchor sets is helpful for efficient tracking.

There are billions of possible anchor set configurations that cover the desired orientations, but only a few of these configurations combine robust tracking with a low number of anchor sets. Initially, for the reduction to practice, the list of anchor sets was selected manually by visually inspecting the target from every orientation and taking note of suitable looking anchor sets. The process worked reasonably well, but in evaluations it failed to achieve better than 90% detection success rate. To overcome this, the reduction to practice used an anchor set selection algorithm to optimize the set of anchor sets for a given optical target. The selection algorithm has three main phases: simulation, optimization, and minimization.

Regarding the simulation phase of the anchor set selection algorithm, the simulation phase generates a large number (e.g., 10,000) of random projections of the optical target with uniform distribution in a specified range of orientations. To sample orientations uniformly, the symmetry around the optical axis of the camera may be ignored, which allows for sampling uniformly over a simple sphere. In each simulated view, the algorithm iterates through all possible permutations of four detected markers and selects the ones that satisfy the requirements (convexity, vertices defined in clockwise order) for anchor sets and contain at least two different types (sizes) of markers. The anchor sets are hashed in a 32-bit unsigned integer (i.e., an easy-to-look-up unique key is associated with each anchor set). Anchor sets are considered identical by the hash function if they are cyclic permutations (for example 3-12-14-7 and 7-3-12-14 are identical). For each view, the algorithm saves the list of anchor-set-hash values, that represent the anchor set candidates visible from the view.

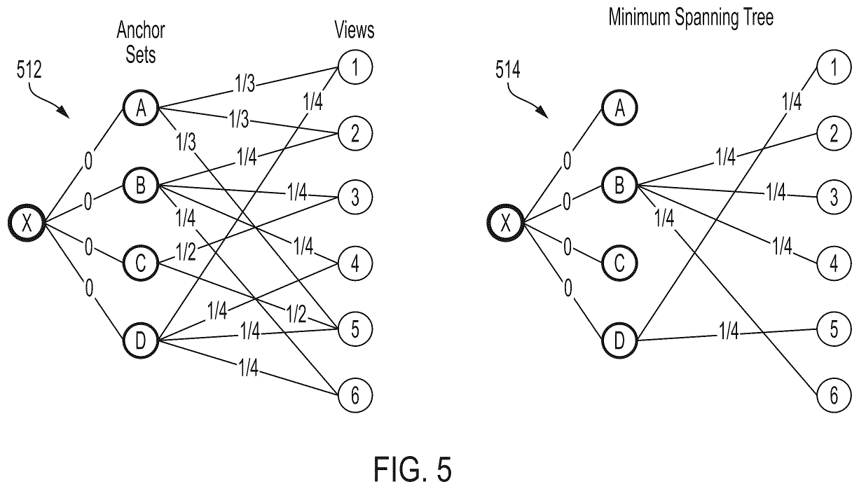

FIG. 5 depicts trees 512, 514 used for the optimization phase of the anchor set selection algorithm. In general, the optimization phase of the anchor set selection algorithm selects a few robustly detectable anchor sets from the candidates identified by the simulation phase simulation that, taken together, cover the entire range of supported orientations. The optimization phase may be formulated as a minimum spanning tree problem. The anchor set candidates, their simulated views, and their relationships are represented in a weighted graph, such as the example weighted graph 512 of FIG. 5. Anchor sets are represented by nodes and labeled by their hash values (nodes labeled A-D in the weighted graph 512). Simulated views are also represented by nodes and labeled by numbers (1-number of views; in the weighted graph 512, the labels are 1-6). Edges between anchor sets and nodes represent the visibility of anchor sets from simulated views. An edge between an anchor set and a view is weighted by the reciprocal of the number of views visible from the anchor set. If the anchor set has N views associated with it, then the edges connecting views to it will all be weighted 1/N. There is one additional root node (labeled X in the weighted graph 512) that is connected to every anchor set by an edge with a weight of zero. Note that in embodiments, the weighted graph will generally be significantly larger than the weighted graph 512, e.g., containing 10,000 simulated views and ~3000 anchor set candidates.

The minimum spanning tree (MST) of the weighted graph, for example, the minimum spanning tree 514 corresponding to the weighted graph 512, has some useful properties. The MST will have exactly one edge connecting each view to one of the anchor sets. For each view the MST will keep only the edge that connects it to the anchor set that has the most associated views. By minimizing the sum of weights of the edges in the spanning tree, the MST will favor a configuration where the views are connected to highly visible anchor sets, while anchor sets with lower visibility tend not to be connected to any views.

The result of the optimization phase is the list of anchor sets that are connected to at least one view. For the target of the reduction to practice, the optimization selects 16-18 anchor sets out of the several thousands. The variability in the number of anchor sets is due to the stochastic nature of the simulation. For the reduction to practice, the optimized anchor sets provide highly robust operation that reduces failure rates by a factor of ~20× compared to manually selected anchor sets.

The optional optimization phase of the anchor set selection algorithm reduces complexity and achieves higher frame rate at the potential expense of slightly degraded tracking reliability. Running the tracker with minimization enabled is designated as FAST mode. While the anchor sets selected by the MST are highly robust due to their high visibility, the number of selected anchor sets is not minimal. The MST has multiple solutions that result in the same minimum weight and the solver selects one unspecified instance of them. However, some of the solutions were preferred over others in the reduction to practice, and reduction of the number of selected anchors improved combinatorial performance.

The ultimate minimal solution includes an additional step of post processing, and it reduces the number of anchors to 9 (for the specific target used in the reduction to practice), approximately half the size of the simple MST solution. This minimal solution is also guaranteed to cover all simulated views and prioritize high visibility anchor sets, however, it will have fewer redundancies (overlaps between regions covered by anchor sets), and therefore it will be somewhat less robust than the simple MST solution.

The minimization phase first sorts the anchor sets in descending order based on how many views they are associated with. Starting from the anchor sets with the lowest visibility, it then examines each one if they are redundant. An anchor set is redundant if all of the views to which it is associated can be accessed through other selected anchor sets. Each anchor set that is found redundant is removed from the list of selected anchor sets.

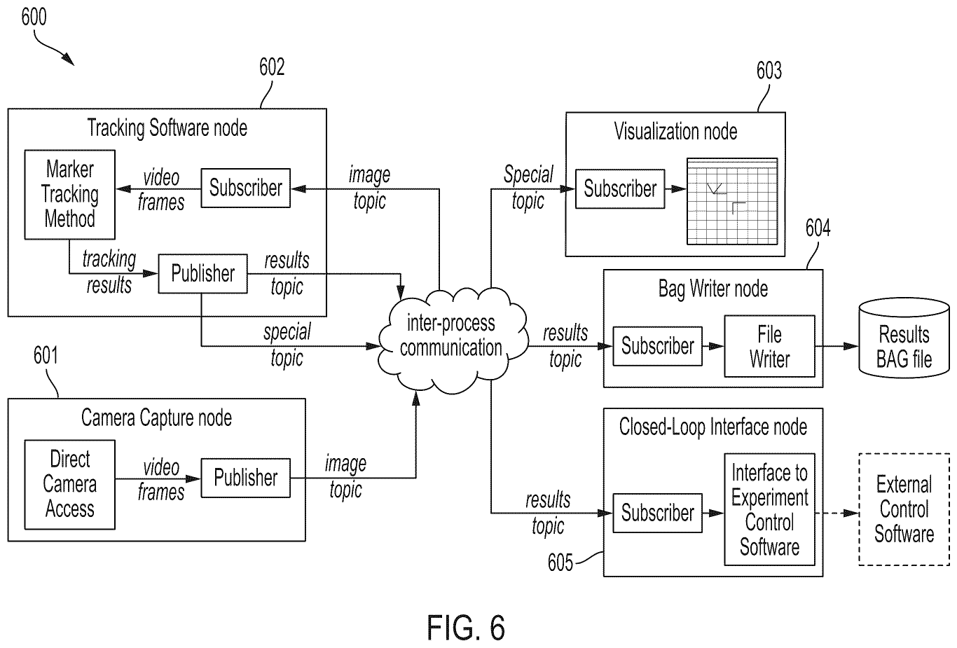

FIG. 6 is a schematic diagram of the system architecture 600 used in the reduction to practice. The tracking system runs uses a robot operating system software framework that supports a wide range of cameras, data recording and playback capabilities, and provides for communication with other software components of the experimental apparatus using “topics.” The robot operating system allowed live tracking results to be accessible by external software in a flexible way. The robot operating system also has the capability to make the interface work locally (i.e., between software programs running on the same computer) and remotely (i.e., tracking software running on a separate computer, accessible through a local network). The robot operating system included built-in data recording and playback functionality. The robot operating system used bag files, which are universal containers for storing one or more simultaneous timestamped data streams, including video data and tracking results. Video data recorded into bag files can be processed offline by the tracker and the software makes sure that video timestamps are carried over to the corresponding tracking results.

Data records transmitted through the robot operating system's topics functionality are always timestamped by the publishing node. Timestamps are defined in Coordinated Universal Time (UTC). In the case of image topics containing live video, the timestamps assigned to video frames are generated by the camera capture node at acquisition time. The timestamp of a tracking result inherits the value of the original timestamp of the video frame to which it belongs. If the tracking software is used in an apparatus that has multiple types of computing hardware, each with a separate clock, the clocks between the computers should be synchronized before running the tracking software. For synchronizing the clocks between multiple computers, the Network Time Protocol (NTP) or Precision Time Protocol (PTP) may be used. Alternately, when the tracking system is used with a neural recording system, which generally is able to accurately timestamp TTL pulses, a DAQ set to generate a randomized TTL pulse train (mean 10 s between pulses, 1 s pulse duration) that is fed into the digital inputs of the neural data acquisition system may be used. The paired timestamps of these pulses may then be used post-hoc to synchronize the neural and experimental data streams using the Needleman-Wunsch algorithm.

As show in FIG. 6, video capture from the camera is handled by the camera capture node 601, which publishes video frames in an image topic. The tracking software node 602 receives the video by subscribing to the image topic, processes video frames (i.e., detects the visual target on images), then publishes the tracking results on a topic and the 3D pose of the target in a special kind of topic for visualization purposes. A visualization tool 603 is capable of visualizing 3D coordinate frames published in the special topic. A bag writer node 604 records timestamped tracking results into bag files. An optional closed-loop interface node 605 may subscribe to tracking results and transmit them to an external control software. This node may be located on a separate computer connected to the tracking computer.

In terms of hardware, the reduction to practice was capable of using up to 8 threads for processing; therefore a 2.3 GHz 8-core mobile Intel 9 CPU was used. The frame rate of tracking is variable, as different tracking modes have different computational complexities. However, embodiments are not limited to conventional CPU-based computers. Other computers, such as quantum computers, may be used. In general, any computer that an electronic processor, such as a CPU or a quantum processor, may be used according to various embodiments.

The resolution and frame rate of the camera can affect the reliability of the tracking. According to some embodiments, the image resolution is high enough that small markers in the visual target appear at least 4 pixels in diameter. For tracking the rapid motions of a small rodent, a camera with a frame rate of at least 45 fps (frames per second) is appropriate.

According to various embodiments, the optical properties of the camera and its lens are measured and stored in a configuration file. These properties may be described by two sets of intrinsic parameters. The raw intrinsic parameters contain the focal length, the position of the optical center, and the five parameters of radial distortion, all of which may be measured by an offline camera calibration method. The undistorted intrinsic parameters contain the desired focal length and optical center position, which define the geometry of the undistorted image that the tracking algorithm can use for processing. The two sets of parameters together allow for the mapping of each raw image pixel onto an image with perfect perspective projection that is used for easy geometrical calculations.

According to various embodiments, the tracker localizes small bright spots (observations) on the camera image. The retroreflective markers on the target appear as bright spots as long as the illumination is appropriate and the exposure parameters are correctly set for the camera. In order to minimize the brightness of other objects and the environment in the field of view, the intensity of illumination from the ring light mounted around the lens may be high enough so that they appear significantly brighter than other features. Other reflective objects and light sources in the view may interfere with tracking performance and may therefore be removed from the environment.

Camera exposure may be set to manual mode and the shutter speed may be increased until the bright spots representing the markers stop being saturated. Saturation may be characterized by a flat white appearance; therefore, the shutter speed may be increased until the spots appear to have a spherical brightness profile with darker shades around the edges and a bright peak in the middle. Shorter exposure times (faster shutter speeds) also reduce motion blur in the images, which may significantly improve tracking reliability. According to various embodiments, good tracking performance uses an exposure time of under 2 ms.

The following describes setting up the visual target according to various embodiments. The visual target can be characterized as a point cloud in 3D space with each marker represented by a point. The description of each point includes its 3D coordinate, size class and visibility angle. The coordinates can be obtained from the CAD model of the target or estimated from multiple 2D images through image processing methods such as bundle adjustment. In the visual target of the reduction to practice, two different sizes of markers were used. The visibility angle specifies the range of angles from which the marker is visible. The small marker types on the visual target are hemispherical therefore their view angle is more limited than the large markers, which are spheres. According to some embodiments, instead of using a CAD model, the coordinates, size classes, and visibility angles can be obtained from a constructed target by capturing images of it from multiple angles and reconstructing the marker positions therefrom.

Users may want to capture 3D tracking results with respect to a reference frame that is different from the camera's coordinate frame. For example, a particular point and orientation in the animal's test environment may be used to define the reference frame. To facilitate this, some embodiments allow the user to specify the position and orientation of an optional reference frame in the configuration file.

The following describes various evaluations of accuracy and reliability of the reduction to practice. The evaluations included behavioral and neurophysiological recordings using 5-8 months old male and female Long-Evans (Envigo Harlan) rats that weighed 250-450 g (gender dependent) at the time of surgery. For verifying accuracy, the inventors compared the results from the reduction to practice to those of a surgical-grade commercial optical tracking solution. Reliability was evaluated by mounting the visual target on a rat's head, tracking the animal while it was roaming in an open arena, and analyzing the recorded tracking results. The near IR camera used for evaluating the reduction to practice's accuracy and reliability was a Grasshopper3 USB3 (GS3—U3-41C6NIR-C, Flir Systems Inc., OR, USA) with a resolution of 2048×2048 driven at the framerate of 45 frames per second. The LEDs of the Near IR ring light (QBLP670-IR3, QT Brightek, CA, USA) were of 850 nm wavelength.

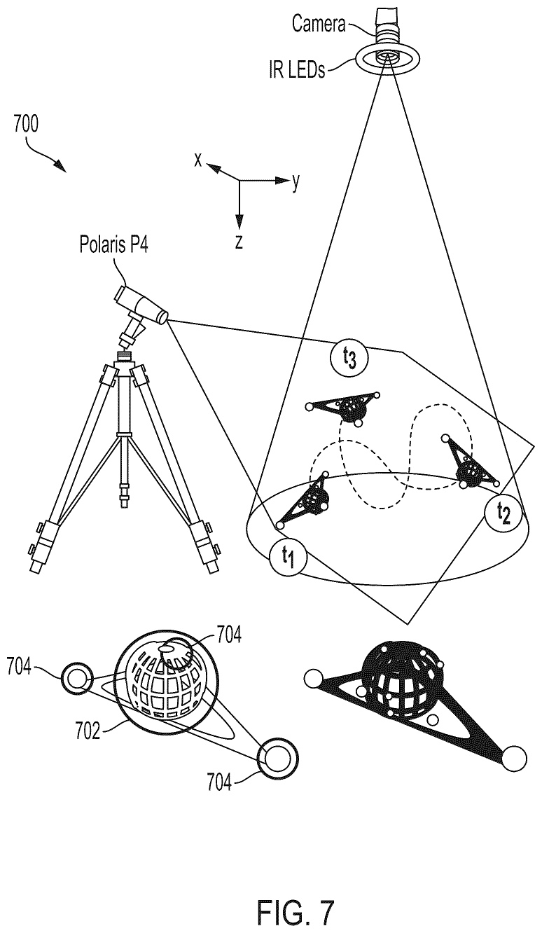

The accuracy of the reduction to practice was measured by comparing its tracking results to pose data acquired by a Polaris P4, a commercial wide-baseline stereoscopic optical tracker (Northern Digital Inc. (NDI), Ontario, Canada). The P4's average accuracy is better than 0.25 mm (<0.5 mm in 95% confidence interval), making it suitable for collecting ground truth data. The experimental setup is shown in FIG. 7.

FIG. 7 illustrates an experimental setup 700 used to evaluate the accuracy of the reduction to practice. The accuracy of the reduction to practice was measured using a surgical-grade, high-precision, wide-baseline (stereo) optical tracker (NDI's Polaris P4). The visual target 702 was rigidly mounted on a triangular frame that featured three large NDI retroreflective markers 704 in its corners. During the evaluation, the P4 was tracking the locations of the three large marker from the side, while reduction to practice was tracking the visual target using the camera mounted above, facing down, at a distance of ~2 m from the target. The target was moved by hand in a random trajectory (dashed line) while making sure that all three large markers were always visible to the P4. Tracking data was recorded into a bag file from both the Polaris and the reduction to practice.

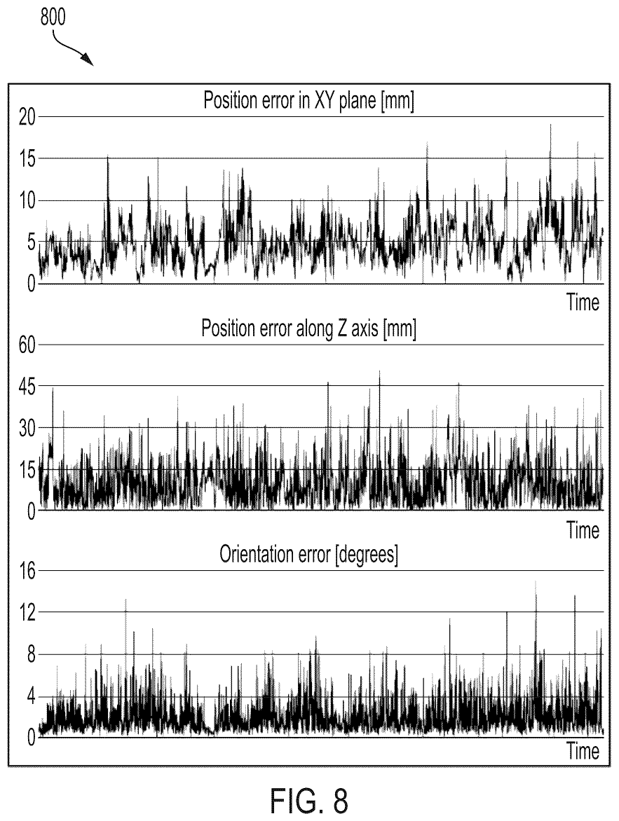

The Polaris optical tracker was placed at ~120 cm from the visual target, looking at the scene at a ~45° angle compared to the angle of the reduction to practice camera. After data capture, the two datasets were registered to each other (aligned the 3D positions and orientations), then the positions and orientations calculated by the reduction to practice were compared to the ground truth captured by the Polaris. The measured tracking errors are visualized in FIG. 8, and Table 1 (non-scaled) breaks down errors by coordinate axes. The average position error was highest in the Z (vertical) direction (9.75 mm) and lowest in the XY plane (4.84 mm).

FIG. 8 depicts graphs 800 comparing position and orientation accuracy of the reduction to practice to a commercially available system. The top graph shows position errors along the plane parallel to the image plane (XY), which were lower than the errors measured along the camera axis (Z) (middle graph), which is expected due to the difficulty of accurately resolving distance from a single camera view. The bottom graph shows mean orientation error was 1.96°.

During the analysis, the inventors noticed that the target trajectory calculated by the reduction to practice was scaled ~2% larger than the trajectory provided by the Polaris. This consistent discrepancy was likely due to inaccuracy in camera intrinsic calibration. Using a camera focal length for 3D pose estimation estimate that is 2% off the actual value would result in the same trajectory scale difference. After correcting for the 2% scale factor difference, the accuracy of the tracker improved from 10.9 mm to 10.16 mm, as shown in Table 1, below.

TABLE 1

| | | Non-Scaled | | Scaled | |
|---|---|---|---|---|---|
| | Unit | Mean | Mean | StDev | |
| Position Error (XYZ) | mm | 10.90 | 7.96 | 10.16 | 7.73 |
| Position Error (XY) | mm | 4.84 | 2.51 | 3.30 | 2.20 |
| Position Error (Z) | mm | 9.75 | 7.55 | 9.60 | 7.41 |
| Orientation Error | degrees | 1.96 | 1.56 | 1.96 | 1.56 |

The focal length—and other parameters—calculated during camera calibration are estimates, typically characterized by mean and variance. For 3D pose estimation, the mean values are typically used; however, the mean only represents the best estimate within a range. Camera calibration uncertainties, manifest as high variance estimates, can be mitigated in a number of ways, such as increasing the number of calibration images or using larger calibration objects. Fortunately, an overall 2% uniform scaling of animal head trajectories would not likely change the overall interpretations of the types of behavioral data investigated, but this sensitivity to camera intrinsic calibration accuracy does highlight a disadvantage of monocular 3D tracking compared to multi-camera tracking methods.

A simple method for determining the focal length accuracy is to move the visual target to two distant known positions in the camera's field of view and compare the distance calculated by the tracker to the known physical distance. The measured scale factor between the two distances can be used to compensate the focal length of the camera.

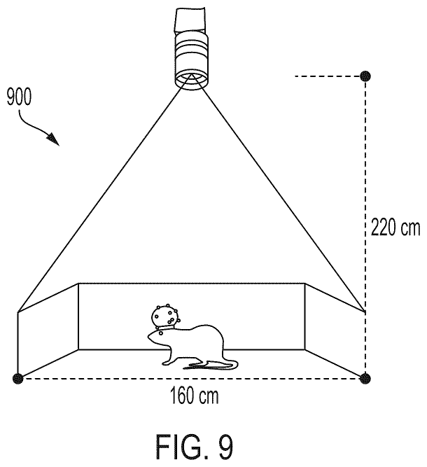

For determining the reliability of the proposed 3D tracker, the inventors performed a series of laboratory experiments tracking the head of a rat moving freely in an open arena within the field of view of the camera, as shown in FIG. 9.

FIG. 9 depicts a setup 900 used to test the reliability of the reduction to practice. As show, reliability testing of the reduction to practice was performed with a live rat subject. The visual target was mounted on the head on the animal. The rat was freely roaming in a 1.6 m by 1.6 m size arena that was placed under the camera at a distance of 2.2 m. In four recording sessions a total of ~2.5 h of data was recorded. Videos were captured at 45 frames per second (fps) from the camera. The video recordings were processed with two different tracker configurations: one with anchor sets optimized empirically by an operator and one with automatic anchor set optimization. Both results are shown in Table 2.

TABLE 2

| | Duration | | Manual | | Optimized | |
|---|---|---|---|---|---|---|
| | [min] | [frm cnt] | [frm cnt] | [%] | [frm cnt] | [%] |
| Run 1 | 44.48 | 116,836 | 7,966 | 6.82 | 635 | 0.54 |
| Run 2 | 31.13 | 79,992 | 5,972 | 7.47 | 482 | 0.60 |
| Run 3 | 22.12 | 58,854 | 3,878 | 6.59 | 177 | 0.30 |
| Run 4 | 50.12 | 126,408 | 20,131 | 15.93 | 866 | 0.69 |
| Total | 147.85 | 382,088 | 37,947 | 9.93 | 2,160 | 0.57 |

In Table 2, failure rates are specified (in frame count and percentage of all frames) for both manually selected anchor sets (N=9) and computationally optimized anchor sets (N=9). In the 2.5 h long evaluation session, the reduction to practice successfully tracked the 3D pose of the rat's head on 99.4% of the video frames when automatic anchor set optimization was enabled. This compares to the 90.1% 3D tracking success rate when the anchor sets were manually optimized by an experienced operator.

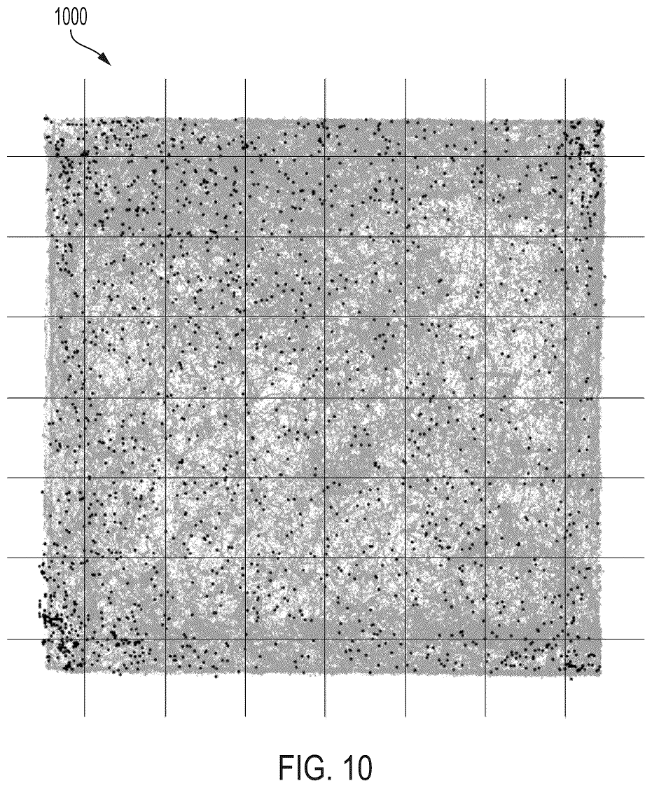

FIG. 10 shows the trajectory 1000 of the visual target of the reduction to practice mounted on the head of the animal during the 2.5 h run time of the experiment with automatic anchor set optimization enabled. Small light dots represent the positions of the rat's head on 379,928 video frames when the tracker succeeded in accurately calculating the 3D pose of the target. 2160 large dark dots (size exaggerated for visibility) show the positions of the target when it was partially visible but the tracker was unable to determine its 3D pose. In these failure cases, the tracker provides a position estimate based on the 2D position of the cluster of light dots near the region of interest. The spatial distribution of target locations where the tracker failed to provide 3D pose estimates appears to be sparse and uniform in the central part of the arena, but the density of failed detections is higher in or near corners. In the corners, the animals tended to rear up, groom, or otherwise occlude the view of the target from the camera, which resulted in fewer observations and valid anchor sets.

The videos were processed offline with simulated playback of the recordings at the original 45 fps. Average offline processing speed of the tracker was 44.4 fps with a minimum framerate of 10.0 fps. The lowest framerates are experienced immediately after a rapid change of orientation of the visual target that may force the tracker to evaluate a high number of anchor sets for correspondence matching. The evaluation was performed on an Apple MacBook Pro 16″ equipped with a 2.3 GHz 8-core mobile Intel 9 CPU, running the Ubuntu 18.04 64-bit operating system on a virtual machine.

The inventors also compared the performance of a popular monocular 3D tracker solution to the reduction to practice. ArUco is an ARTag-based tracker that is widely used in augmented reality, robotics, and scientific experiments. In order to provide a fair comparison to the reduction to practice, the inventors printed an ArUco marker of the same size, 54 mm by 54 mm, as the reduction to practice visual target and tracked it with the same camera used for the evaluation of the reduction to practice.

During testing, the inventors managed to successfully track the marker with ArUco up to ~1.5 m distance from the camera. When the marker was moved any farther away, the tracker failed to provide any position or orientation estimate. Furthermore, even when the marker was closer than 1.5 m to the camera, ArUco only managed to locate it in an approximately ±70° range of angles relative to the front view. When the marker appeared at a sharper angle (>70°), the detection rate quickly plummeted and detection failed completely at around 75°.

Compared to ArUco, in the evaluations, the reduction to practice had a success rate of 99.43% at 2.1 m distance from the camera and a range of supported orientations of up to ±120°.

To demonstrate the applicability of the reduction to practice in neurophysiological research, the inventors performed chronic neural recordings from laboratory rats as they circumnavigated a circular environment. The neural recordings were performed using multi-tetrode hyperdrives.

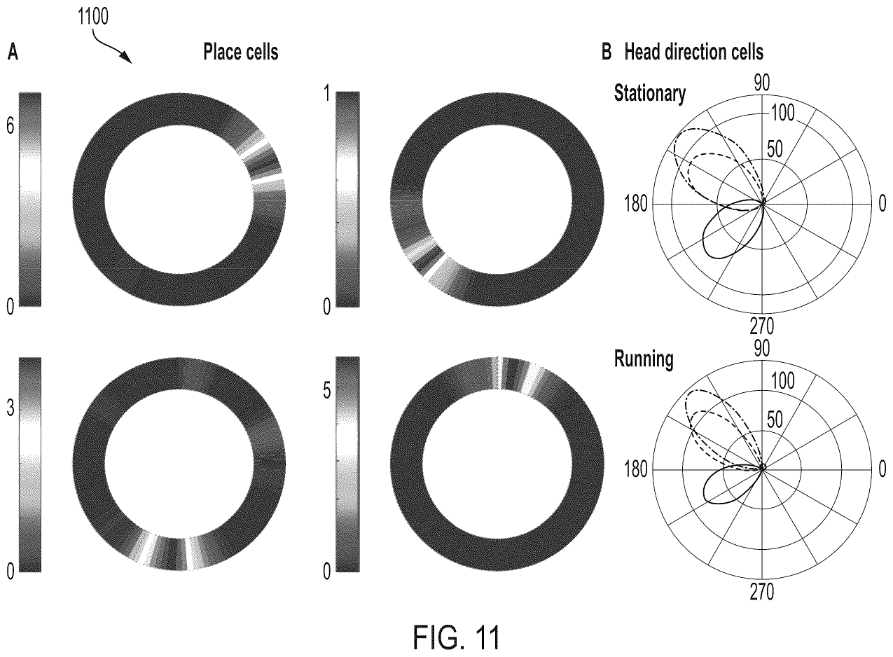

FIG. 11 shows the spatially selective neural activity 1100 of typical head direction cells and place cells from a single session of a rat running on a circular track collected using the reduction to practice. On the left are four example place cells. The annulus represents the circular track and color indicates occupancy-corrected firing rate in Hz (bar indicates scale). On the right are polar plots of three head direction cells. The radius represents occupancy corrected firing rate in Hz, and the angle represents allocentric heading direction of the animal. The top plot shows the directional tuning when the animal is stationary and bottom plot shows tuning when running. The sharp spatially selective tuning of place cells (with respect to position) and head direction cells (with respect to head orientation) provide demonstrative evidence of the utility of the reduction to practice for neurophysiological applications.

Thus, disclosed herein is a monocular (single-camera) optical tracking system that includes a small, compact, and lightweight visual target and software capable of tracking the target at a high frame rate in real time based on camera images. Various embodiments improve upon the state of the art by providing accurate 3D pose (position and orientation) at a wider range of orientations than other tracking systems. Performance evaluations using synthetic tests and laboratory rats demonstrated high accuracy and reliability. The use of a single camera and 3D printable visual target keeps setup simple and inexpensive, while maintaining flexibility for users to adapt the visual target for other applications with minimal effort.

In extensive testing—benchmarking against a commercial system and several live animal experiments—a reduction to practice proved to be more accurate, robust, and effective over a larger range of angles than other state-of-the-art monocular tracking solutions. A significant advantage is the extended range of trackable angles of the marker. Most other marker-based systems rely on markers that are only visible from a single side of the marker (visibility <90°), but some embodiments are able to track its visual target in a significantly wider range of angles, up to ±120°. This extended range allows for, for example, the tracking of a larger variety of animal behavior than before. The physical setup of the is straightforward as it utilizes a computer, single camera, a ring light, and the visual target that is mounted on the object to be tracked, according to various embodiments.

Certain embodiments can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method of tracking an orientation of an object in a three-dimensional environment using image information acquired by a single camera, the method comprising:
acquiring, from the single camera, a marker image, the marker image depicting a portion of a set of markers rigidly positioned with respect to the object;
for a predetermined anchor subset of the set of markers, determining, by an electronic processor communicatively coupled to the single camera, a plurality of correspondences of a plurality of markers in the anchor subset of markers to subsets of images of markers depicted in the marker image;
determining, by the electronic processor, for each of the plurality of correspondences, a respective orientation of the object;
predicting, by the electronic processor, for each respective orientation of the object, a respective predicted position of a non-anchor marker, wherein a plurality of predicted positions of the non-anchor marker are determined;
identifying, by the electronic processor, a closest match of the marker image to one of the plurality of predicted positions of the non-anchor marker;
determining, by the electronic processor, an output orientation of the object corresponding to the closest match; and
providing, by the electronic processor, the output orientation of the object.

2. The method of claim 1, wherein the object is attached to an animal.

3. The method of claim 1, wherein the object comprises a robot end effector.

4. The method of claim 3, further comprising controlling the robot end effector based on the output orientation.

5. The method of claim 1, wherein the marker image is monochromatic.

6. The method of claim 1, further comprising:
determining an output position of the object based on the marker image; and
providing an output position of the object.

7. The method of claim 1, performed without use of a graphics processing unit (GPU).

8. The method of claim 1, further comprising illuminating the object using a near infrared ring light positioned about an aperture of the camera.

9. The method of claim 1, further comprising determining a subsequent output orientation of the object based on at least two prior output orientations of the object.

10. The method of claim 1, further comprising, prior to the acquiring, determining a plurality of anchor subsets of the set of markers, wherein the plurality of anchor subsets of the set of markers comprise the predetermined anchor subset of the set of markers.

11. A computer readable medium comprising instructions that, when executed by an electronic processor, configure the electronic processor to perform a method of tracking an orientation of an object in a three-dimensional environment using image information acquired by a single camera by performing actions comprising:
acquiring, from the single camera, a marker image, the marker image depicting a portion of a set of markers rigidly positioned with respect to the object;
for a predetermined anchor subset of the set of markers, determining, by an electronic processor communicatively coupled to the single camera, a plurality of correspondences of a plurality of markers in the anchor subset of markers to subsets of images of markers depicted in the marker image;
determining, by the electronic processor, for each of the plurality of correspondences, a respective orientation of the object;
predicting, by the electronic processor, for each respective orientation of the object, a respective predicted position of a non-anchor marker, wherein a plurality of predicted positions of the non-anchor marker are determined;
identifying, by the electronic processor, a closest match of the marker image to one of the plurality of predicted positions of the non-anchor marker;
determining, by the electronic processor, an output orientation of the object corresponding to the closest match; and
providing, by the electronic processor, the output orientation of the object.

12. The computer readable medium of claim 11, wherein the object is attached to an animal.

13. The computer readable medium of claim 11, wherein the object comprises a robot end effector.

14. The computer readable medium of claim 13, wherein the actions further comprise controlling the robot end effector based on the output orientation.

15. The computer readable medium of claim 11, wherein the marker image is monochromatic.

16. The computer readable medium of claim 11, wherein the actions further comprise:
determining an output position of the object based on the marker image; and
providing an output position of the object.

17. The computer readable medium of claim 11, wherein the actions are performable without use of a graphics processing unit (GPU).

18. The computer readable medium of claim 11, wherein a near infrared ring light positioned about an aperture of the camera illuminates the object.

19. The computer readable medium of claim 11, wherein the actions further comprise determining a subsequent output orientation of the object based on at least two prior output orientations of the object.

20. The computer readable medium of claim 11, wherein the actions further comprise, prior to the acquiring, determining a plurality of anchor subsets of the set of markers, wherein the plurality of anchor subsets of the set of markers comprise the predetermined anchor subset of the set of markers.
